(19) United States
(12) Patent Application Publication
(10) Pub. No.: US 2003/0096419 A1
(43) Pub. Date: May 22, 2003

(54) Method for determining whether a fluid in an air-conditioning or refrigeration system has been altered

(76) Inventor: Phil Trigiani, Mississauga (CA)

Correspondence Address: BELL, BOYD & LLOYD LLC, P.O. Box 1135, Chicago, IL, 60690-1135, US

(21) Appl. No.: 10/281,625

(22) Filed: Oct. 28, 2002

Related U.S. Application Data
(60) Provisional application No. 60/332,169, filed on Nov. 16, 2001.

(51) Int. Cl. G01N 37/00

(52) U.S. Cl. 436/56; 436/139; 436/140; 436/60; 436/161; 436/173

(57) ABSTRACT

A method for determining whether a fluid in an air-conditioning or refrigeration system has been altered is revealed. The method comprises preparing a non-radioactive label for a fluid used in the system, where the fluid is selected from a lubricant, a fluorescent dye and combinations thereof; adding a known quantity of the label to the fluid to form a labeled mixture of the fluid; performing an analysis of the labeled mixture to obtain a base-line profile of the labeled mixture; adding the labeled mixture to the system; providing the system to a user or customer; thereafter, performing an analysis of the fluid in the system to obtain a test profile; and determining whether the fluid in the system has been altered by comparing the base-line profile with the test profile of the fluid in the system.

The present application is directly related to U.S. Provisional Patent Application No. 60/332,169, filed Nov. 16, 2001, the entire contents of which are hereby incorporated by reference and relied upon.

### BACKGROUND OF THE INVENTION

1. Field of the Invention

The present application discloses a method for determining whether a fluid (a lubricant and/or fluorescent detection dye) in an air-conditioning or refrigeration system has been altered. The method uses uniquely identifiable (marker) lubricants and/or detection dyes.

2. Description of the Related Art

Detecting leaks in air-conditioning and refrigeration systems has become of paramount and key importance for vehicle manufacturers. The most effective and efficient method of leak detection involves the injection of a fluorescent dye mixed with lubricant into the system and then inspecting the systems with an ultraviolet detection lamp for evidence of leakage of the fluorescent dye from the system.

More specifically, it is a well-known phenomenon that electromagnetic energy within the near ultraviolet spectrum of approximately 315 to 400 nanometer wavelengths produces fluorescence in certain materials. That is, the fluorescent materials absorb radiated energy at the near UV or blue wavelengths and re-radiate or emit it at a longer wavelength in the visible spectrum. Thus, when fluorescent material absorbs electromagnetic energy in a specific excitation frequency band in a specific wavelength range, the material can emit electromagnetic energy in a characteristic fluorescent emission frequency band within the visible light spectrum.

This phenomenon has enabled inspection and detection techniques in which fluorescent dyes, inks or pigments are illuminated by lamps selectively filtered to emit only ultraviolet radiation (invisible to the human eye) and then re-radiate with a high luminescence in the visible spectrum.

For example, the slow leakage of refrigerant from an air-conditioning system is difficult to locate by any other means. The reason for the difficulty is because the refrigerant escapes as an invisible gas at such a low rate with rapid diffusion that the concentration of refrigerant in air near the leak site is difficult to differentiate from that surrounding any other location along the system circulation lines. However, by infusing a small amount of fluorescent dye into the circulating system, the dye is carried out of the system with the refrigerant and glows brightly at the leak site when the area is swept with a UV lamp (see, for example, U.S. Pat. No. 5,357,782; U.S. Patent Re. 35,370; U.S. Patent Re. 35,395; and U.S. Pat. No. 5,681,984).

A similar procedure can be used to locate leaks of other fluids, such as lubricants, oils, fuels, heat transfer fluids or hydraulic fluids. Other UV inspection techniques use fluorescent dyes or paint to detect fissures or stress cracks in structural members.

Petroleum fuels are often tagged for the purpose of identifying grades or tax category. Markers for the tagging of petroleum fuels are described, for example, in U.S. Pat. No. 4,209,302; U.S. Pat. No. 4,904,765; U.S. Pat. No. 5,156,653; U.S. Pat. No. 5,205,840; and U.S. Pat. No. 5,252,106. The markers used for tagging petroleum fuel are intended to be silent, i.e., to provide no significant coloration to the petroleum fuel. They may be naturally colorless or insignificantly colorful at the concentration used in tagging petroleum, or they may be used in conjunction with dyes which mask any color the marker may impart. Such markers, however, are extractable with aqueous solutions, which depending upon the marker may be acidic, basic, and/or may contain an alcohol. The markers also are capable of undergoing a chromophoric change to produce an intense color, such as by reaction with the acid or base of the aqueous solution or with another chemical reagent which may be included in the extracting aqueous solution or subsequently added thereto.

Vehicle manufacturers use specific lubricants and fluorescent dyes in their air-conditioning and refrigeration systems. Likewise, the manufacturers of fluorescent detection systems use specific fluorescent dyes and lubricants in their detection systems. These manufacturers normally guarantee the quality of their products. However, counterfeiting, substitution and gray market sales of the manufacturers' brand name products are an ever-present threat. Such practices result in lost revenue to the manufacture and the sale of an inferior product to the consumer. The use of the substandard product can lead to product liability claims against the manufacturer and no manufacturer wants to pay for equipment failure not caused by its brand name product.

Another issue, since the widely accepted use of dyes has occurred, is the overuse of dyes. In general, if a vehicle is charged with two to three times the required dose of the dye, the leak may not fluoresce at all as the excess dye may cause a masking effect not allowing the excited dye to be visible to the operator. Also, the additional dye may dilute the air-conditioning system lubricant to a point that may cause changes in viscosity and other physical, as well as chemical changes, and wear characteristics causing failures in components.

U.S. Pat. No. 5,560,855 discloses a method of tagging and subsequently identifying refrigerant lubricants. More specifically, a polyol ester or polyalkylene glycol is tagged by adding to the lubricant a chemical marker which is stable over the temperature cycling range of a refrigerant. In testing for the presence of the marker, a sample of a lubricant is obtained, and the sample is diluted in a sufficient volume of an organic solvent such that subsequent admixture with an aqueous solution will not result in emulsification. The diluted sample is extracted with an aqueous solution appropriate for the marker. Simultaneous with or subsequent to extraction, a chromophoric reaction of the marker is induced, whereby a readily identifiable color is observable.

However, a method for determining whether a fluid in an air-conditioning or refrigeration system has been altered has not been disclosed. Thus, there is a need in the air-conditioning and refrigeration industry and in the leak detection industry for a method for determining whether a fluid (lubricants and/or fluorescent detection dyes) in air-conditioning or refrigeration systems have been altered. Such a method will ensure that each manufacturer's product has not been counterfeited or substituted.

There is also a need to be able to identify that there is sufficient dye in a system. When the system leaks, if it were a major leak and a substantial amount of fluid leaked out in a sudden discharge, there may not be enough residual dye to effectively find any further leaks after the system has been put back in service. Also, there is a need to verify that there is not too much dye in a system that could be harmful to the system and limit the leak finding potential.

### SUMMARY OF THE INVENTION

The present application discloses a method for determining whether a fluid in an air-conditioning or refrigeration system has been altered. The method comprises the steps of preparing at least one non-radioactive label for a fluid used in an air-conditioning system or refrigeration system, where the fluid comprises a compound selected from the group consisting of a lubricant, a fluorescent dye and combinations thereof; adding a known quantity of the label to the fluid used in the air-conditioning or refrigeration system to form a labeled mixture of the fluid; performing an analysis of the labeled mixture of the fluid to obtain a base-line profile of the labeled mixture of the fluid; adding the labeled mixture of the fluid to an air-conditioning or refrigeration system; providing the air-conditioning or refrigeration system to a user or customer; thereafter, performing an analysis of the fluid in the air-conditioning or refrigeration system to obtain a test profile of the fluid in the air-conditioning or refrigeration system; and determining whether the fluid in the air-conditioning or refrigeration system has been altered by comparing the base-line profile of the labeled mixture with the test profile of the fluid in the air-conditioning or refrigeration system.

In preferred embodiments of the method, the label is not normally present in the fluid; the label is deuterated; the analysis comprises chromatography; the analysis comprises mass spectrometry; and/or the analysis comprises chromatography and mass spectrometry.

In another preferred embodiment, the method further comprises a second label, where the chemical label is deuterated.

In yet other preferred embodiments, the lubricant is selected from the group consisting of mineral oil, alkyl benzenes, PAG oil, POE oil and combinations thereof; the label is a polynuclear aromatic hydrocarbon or a halogenated hydrocarbon; and the label is selected from the group consisting of 1,2-diphenylbenzene; 1,4-diphenylbenzene; triphenylmethane; 1,3,5-triphenylbenzene; 1,1,2-triphenylethylene; tetraphenylethylene; 1,2,3,4-tetrahydrocarbazole; 4-4′-dichlorobenzophenone; 4-benzoylphenone; 4-bromobenzophenone; 4-methoxybenzophenone; 4-methylbenzophenone; 9-fluorenone; 1-phenylnapthalene; 3,3′-dimethoxybiphenyl; and 9-phenylanthracene.

In yet another preferred embodiment, the label is selected from the group consisting of 1-(4-morpholino)-3-(alpha naphthylamino)-propane; 1-(4-morpholino)-3-(beta naphthylamino)-propane;

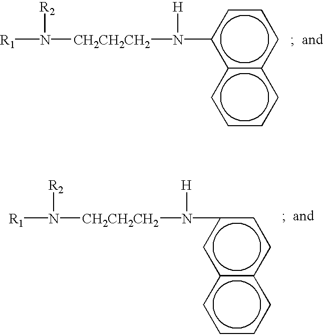

where R₁ and R₂ may each be hydrogen or alkyl having from one to twenty carbon atoms.

In yet another preferred embodiment, the label has the formula:

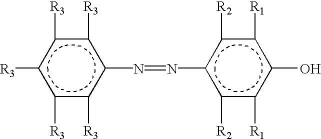

wherein the R₁'s and the R₂'s are the same or different and are each selected from —H and C₁-C₇ alkyls, provided that at least one R₁ is a C₃-C₇ alkyl, provided that the R₃'s are the same or different and are selected from —H, —NO₂, —Cl, —Br, —F, —CN, -Et and -Me, and provided that at least one R₃ is selected from —NO₂, —Cl, —Br, —F and —CN.

### DETAILED DESCRIPTION

The present invention provides a method for determining whether a fluid in an air-conditioning or refrigeration system has been altered. The method uses uniquely identifiable or marker lubricants and/or detection dyes mixed with standard lubricants and/or detection dyes. Any marker so used must be added in small concentrations, should not affect the physical or chemical properties of the substances to which it is added and should be easily identified by relatively quick and simple means.

Currently, the most effective and efficient method for detecting leaks in an air-conditioning or refrigeration system involves the injection of a fluorescent dye mixed with lubricant into the system and then inspecting the system with an ultraviolet detection lamp for evidence of leakage of the fluorescent dye from the system.

Uniquely identifiable non-radioactive lubricants and/or detection dyes are prepared to specifically identify a manufacturer's product. Thus, the manufacturer of an air-conditioning system produces the system containing a standard lubricant and a known quantity of a lubricant that is uniquely identifiable. Moreover, the manufacturer may also produce the system with lubricant containing standard lubricant, a standard fluorescent detection dye and a known quantity of a uniquely identifiable fluorescent detection dye. Likewise, the manufacturer of a fluorescent leak detection system can produce a system with a standard lubricant mixed with a known quantity of a marker lubricant and a standard fluorescent dye mixed with a known quantity of a marker fluorescent dye. Such methods will ensure that each manufacturer's product has not been counterfeited or substituted.

There are at least two methods for preparing a lubricant that is uniquely identifiable. The first method involves adding a unique substance or label to the standard lubricant that is normally not present in the standard lubricant. There are at least four standard lubricants for air-conditioning or refrigeration systems. Mineral oil (petroleum derivative, naphthenic mineral oil, comes from the fractionation of crude oil) is used as the lubricant in systems employing R12 refrigerant; alkyl benzenes (synthetic) in systems employing R22 refrigerant; PAG oil (synthetic, polyalkylene glycol, polyoxyalkylene glycol) in systems employing R134A refrigerant; and POE oil (synthetic, ester, polyol ester) in systems employing R134A refrigerant.

A non-radioactive organic compound that is not normally found in the standard lubricant is then added to the standard lubricant to a final concentration of between 0.1 ppb and 500 ppm. Thus, the added compound or label and its concentration are specific in the resulting lubricant mixture.

Two classes of suitable materials which can be used as labels are polynuclear aromatic hydrocarbons and halogenated hydrocarbons. Examples of suitable labels include 1,2-diphenylbenzene; 1,4-diphenylbenzene; triphenylmethane; 1,3,5-triphenylbenzene; 1,1,2-triphenylethylene; tetraphenylethylene; 1,2,3,4-tetrahydrocarbazole; 4-4′-dichlorobenzophenone; 4-benzoylphenone; 4-bromobenzophenone; 4-methoxybenzophenone; 4-methylbenzophenone; 9-fluorenone; 1-phenylnapthalene; 3,3′-dimethoxybiphenyl; and 9-phenylanthracene.

Another class of suitable materials which can be used as labels include 1-(4-morpholino)-3-(alpha naphthylamino)-propane; 1-(4-morpholino)-3-(beta naphthylamino)-propane;

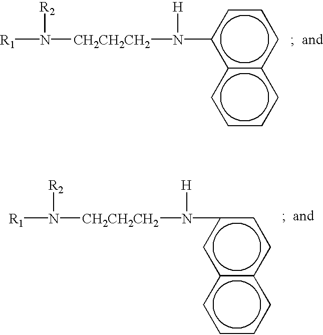

where R₁ and R₂ may each be hydrogen or alkyl having from one to twenty carbon atoms.

Another class of suitable materials which can be used as markers have the formula:

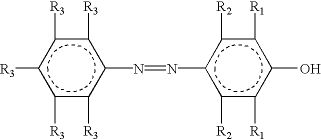

wherein the R₁'s and the R₂'s are the same or different and are each selected from —H and C₁-C₇ alkyls, provided that at least one R₁ is a C₃-C₇ alkyl, provided that the R₃'s are the same or different and are selected from —H, —NO₂, —Cl, —Br, —F, —CN, -Et and -Me, and provided that at least one R₃ is selected from —NO₂, —Cl, —Br, —F and —CN.

The second way to prepare a lubricant that is uniquely identifiable is to add an isotope of a component of the standard lubricant to the standard lubricant. For example, polyol ester is a normal component of standard air-conditioning lubricant used with R134A refrigerants in air-conditioning and refrigeration systems. A deuterated polyol ester is separately manufactured and added to the standard lubricant to a final concentration of between 0.1 ppb and 500 ppm. The deuterated component and its concentration are specific in the resulting lubricant mixture.

The method for preparing a fluorescent dye that is uniquely identifiable is to add an isotope of the standard fluorescent dye to the standard fluorescent dye. Typically, the automotive detection industry uses napthalene or naphthalamide fluorescent dyes as standard dyes. For example, the dye may be Fluorescent Yellow 43. A deuterated Fluorescent Yellow 43 is separately manufactured and added to the standard Fluorescent Yellow 43 to a final concentration of between 0.1 ppb and 500 ppm. The deuterated Fluorescent Yellow 43 and its concentration are specific in the resulting fluorescent dye mixture.

Regardless of how the lubricant mixture or the fluorescent dye mixture is prepared, the method for testing the concentration of a uniquely identifiable substance in the mixture is the same, that is, the mixture is subjected to analysis, for example, gas or liquid chromatography, or mass spectrometric analysis. The results of the analysis establish a baseline profile for the labeled mixture of the fluid.

After the labeled mixture of the fluid has been added to an air-conditioning or refrigeration system, the system is provided to a user or customer. Should the air-conditioning or refrigeration system be returned to the manufacturer or representative for service, the manufacturer or representative can test the fluid in the system to determine whether the fluid has been altered, thereby voiding the manufacturer's warranty. The manufacturer or representative will perform an analysis of the fluid in the air-conditioning or refrigeration system to obtain a test profile of the fluid in the air-conditioning or refrigeration system. The manufacturer or representative can then determine whether the fluid in the air-conditioning or refrigeration system has been altered by comparing the base-line profile of the labeled mixture with the test profile of the fluid in the air-conditioning or refrigeration system.

### EXAMPLES

The following examples are included to demonstrate preferred embodiments of the invention. It should be appreciated by those skilled in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the concept, spirit and scope of the invention.

More specifically, it will be apparent that certain process steps may be substituted for the process steps described herein while the same or similar results would be achieved. All such similar substitutes and modifications apparent to those skilled in the art are deemed to be within the spirit, scope and concept of the invention as defined by the appended claims.

### Example 1

An automotive manufacturer prepares or purchases a non-radioactive chemical label, 1,3-diphenylacetone. The 1,3-diphenylacetone is added to the POE oil (synthetic, ester, polyol ester) used as lubricant with R134A refrigerant in the air-conditioning systems of the vehicles manufactured by the automotive manufacturer. The 1,3-diphenylacetone added to the POE oil forms a 1,3-diphenylacetone labeled polyol ester mixture. The concentration of the 1,3-diphenylacetone in the polyol ester is analyzed by chromatography and shown to be 100 ppb. The 1,3-diphenylacetone labeled polyol ester is then added as a lubricant to the air-conditioning systems of the vehicles manufactured by the automotive manufacturer. The vehicles are subsequently sold to customers.

At a later date, a customer returns a vehicle to a manufacturer's representative complaining about the functioning of the air-conditioning system. The manufacturer's representative obtains a sample of the lubricant in the air-conditioning system of the vehicle and performs a chemical analysis of the lubricant to obtain a test profile of the lubricant. The concentration of 1,3-diphenylacetone in the polyol ester is analyzed by chromatography and shown to be 100 ppb. The manufacturer's representative thus determines that the fluid in the air-conditioning system has not been altered and that any needed repairs to the air-conditioning system are covered under the manufacturer's warranty.

### Example 2

An automotive manufacturer prepares or purchases non-radioactive chemical label, deuterated Fluorescent Yellow 43. The deuterated Fluorescent Yellow 43 is added to standard Fluorescent Yellow 43 used as a fluorescent detection dye. The deuterated Fluorescent Yellow 43/standard Fluorescent Yellow 43 mixture is added to the POE oil (synthetic, ester, polyol ester) used as lubricant with R134A refrigerant in the air-conditioning systems of the vehicles manufactured by the automotive manufacturer. The concentration of the deuterated Fluorescent Yellow 43 in the POE oil is analyzed by mass spectrometry and shown to be 40 ppb. The labeled fluorescent dye is added to the air-conditioning systems of the vehicles manufactured by the automotive manufacturer. The vehicles are subsequently sold to customers.

At a later date, a customer returns a vehicle to a manufacturer's representative complaining about the functioning of the air-conditioning system. The manufacturer's representative obtains a sample of the lubricant in the air-conditioning system of the vehicle and performs an analysis of the lubricant to obtain a test profile of the lubricant. The concentration of the deuterated Fluorescent Yellow 43 in the POE oil is analyzed by mass spectrometry and shown to be 20 ppb. The manufacturer's representative thus determines that the fluid in the air-conditioning system has been altered and that any needed repairs to the air-conditioning system are not covered under the manufacturer's warranty.

### Example 3

An automotive manufacturer prepares or purchases non-radioactive chemical labels, 1,3-diphenylacetone and deuterated Fluorescent Yellow 43. The 1,3-diphenylacetone is added to the POE oil (synthetic, ester, polyol ester) used as lubricant with R134A refrigerant in the air-conditioning systems of the vehicles manufactured by the automotive manufacturer. The deuterated Fluorescent Yellow 43 is added to standard Fluorescent Yellow 43 used as a fluorescent detection dye. The deuterated Fluorescent Yellow 43/standard Fluorescent Yellow 43 mixture is added to the 1,3-diphenylacetone labeled polyol ester mixture. The concentration of the 1,3-diphenylacetone in the polyol ester is analyzed by chromatography and shown to be 100 ppb. The concentration of the deuterated Fluorescent Yellow 43 in the polyol ester mixture is analyzed by mass spectrometry and shown to be 40 ppb. The labeled polyol ester is then added as a lubricant and fluorescent dye to the air-conditioning systems of the vehicles manufactured by the automotive manufacturer. The vehicles are subsequently sold to customers.

At a later date, a customer returns a vehicle to a manufacturer's representative complaining about the functioning of the air-conditioning system. The manufacturer's representative obtains a sample of the lubricant in the air-conditioning system of the vehicle and performs an analysis of the lubricant to obtain a test profile of the lubricant. The concentration of 1,3-diphenylacetone in the polyol ester is analyzed by chromatography and shown to be 50 ppb. The concentration of the deuterated Fluorescent Yellow 43 in the polyol ester mixture is analyzed by mass spectrometry and shown to be 20 ppb. The manufacturer's representative thus determines that the fluid in the air-conditioning system has been altered and that any needed repairs to the air-conditioning system are not covered under the manufacturer's warranty.

### Example 4

An automotive manufacturer prepares or purchases a non-radioactive chemical label, 1-(4-morpholino)-3-(alpha naphthylamino)-propane. The 1-(4-morpholino)-3-(alpha naphthylamino)-propane is added to the POE oil (synthetic, ester, polyol ester) used as lubricant with R134A refrigerant in the air-conditioning systems of the vehicles manufactured by the automotive manufacturer. The 1-(4-morpholino)-3-(alpha naphthylamino)-propane added to the POE oil forms a 1-(4-morpholino)-3-(alpha naphthylamino)-propane labeled polyol ester mixture. The concentration of the 1-(4-morpholino)-3-(alpha naphthylamino)-propane in the polyol ester is analyzed by chromatography and shown to be 1 ppm. The 1-(4-morpholino)-3-(alpha naphthylamino)-propane labeled polyol ester is then added as a lubricant to the air-conditioning systems of the vehicles manufactured by the automotive manufacturer. The vehicles are subsequently sold to customers.

At a later date, a customer returns a vehicle to a manufacturer's representative complaining about the function of the air-conditioning system. The manufacturer's representative obtains a sample of the lubricant in the air-conditioning system of the vehicle and performs a chemical analysis of the lubricant to obtain a test profile of the lubricant.

More specifically, the lubricant is extracted with a relatively small portion of an aqueous acidic solution which removes and concentrates the marker in the aqueous phase. The aqueous phase containing the marker is separated from the lubricant and treated with a small quantity of a stabilized solution of diazotized 2-chlor-4-nitroaniline whereupon a characteristic pink coloration develops instantly.

Subsequently, the concentration of 1-(4-morpholino)-3-(alpha naphthylamino)-propane in the polyol ester is analyzed by chromatography and shown to be 1 ppm. The manufacturer's representative thus determines that the fluid in the air-conditioning system has not been altered and that any needed repairs to the air-conditioning system are covered under the manufacturer's warranty.

### Example 5

An automotive manufacturer prepares or purchases a non-radioactive chemical label, phenol, 2,6-bis (1-methylpropyl)-4-[(4-nitrophenyl)azo]. The phenol, 2,6-bis (1-methylpropyl)-4-[(4-nitrophenyl)azo] is added to the POE oil (synthetic, ester, polyol ester) used as lubricant with R134A refrigerant in the air-conditioning systems of the vehicles manufactured by the automotive manufacturer. The phenol, 2,6-bis (1-methylpropyl)-4-[(4-nitrophenyl)azo] added to the POE oil forms a phenol, 2,6-bis (1-methylpropyl)-4-[(4-nitrophenyl)azo] labeled polyol ester mixture. The concentration of the phenol, 2,6-bis (1-methylpropyl)-4-[(4-nitrophenyl)azo] in the polyol ester is analyzed by chromatography and shown to be 0.25 ppm. The phenol, 2,6-bis (1-methylpropyl)-4-[(4-nitrophenyl)azo] labeled polyol ester is then added as a lubricant to the air-conditioning systems of the vehicles manufactured by the automotive manufacturer. The vehicles are subsequently sold to customers.

At a later date, a customer returns a vehicle to a manufacturer's representative complaining about the function of the air-conditioning system. The manufacturer's representative obtains a sample of the lubricant in the air-conditioning system of the vehicle and performs a chemical analysis of the lubricant to obtain a test profile of the lubricant.

More specifically, the lubricant is extracted with a reagent comprising water and a water-soluble amine, and, preferably a water-miscible co-solvent. This reagent system not only extracts the marker from the lubricant but also causes the marker to react or complex, producing a clearly defined bluish-black color having a typical absorbency maximum of 592 nanometers.

Subsequently, the concentration of phenol, 2,6-bis (1-methylpropyl)-4-[(4-nitrophenyl)azo] in the polyol ester is analyzed by chromatography and shown to be 0.25 ppm. The manufacturer's representative thus determines that the fluid in the air-conditioning system has not been altered and that any needed repairs to the air-conditioning system are covered under the manufacturer's warranty.

While the invention has been described in connection with what is presently considered to be the most practical and preferred embodiments, it is to be understood that the invention is not limited to the disclosed embodiments, but on the contrary is intended to cover various modifications and equivalent arrangements included within the spirit and scope of the appended claims.

Thus, it is to be understood that variations in the present invention can be made without departing from the novel aspects of this invention as defined in the claims. All patents and articles cited herein are hereby incorporated by reference in their entirety and relied upon.

What is claimed is:

1. A method for determining whether a fluid in an air-conditioning or refrigeration system has been altered, comprising the steps of:
a) preparing at least one non-radioactive label for a fluid used in an air-conditioning system or refrigeration system,
wherein said fluid comprises a compound selected from the group consisting of a lubricant, a fluorescent dye and combinations thereof;
b) adding a known quantity of the label to the fluid used in the air-conditioning or refrigeration system to form a labeled mixture of the fluid;
c) performing an analysis of the labeled mixture of the fluid to obtain a base-line profile of the labeled mixture of the fluid;
d) adding the labeled mixture of the fluid to an air-conditioning or refrigeration system;
e) providing the air-conditioning or refrigeration system to a user or customer;
f) thereafter, performing an analysis of the fluid in the air-conditioning or refrigeration system to obtain a test profile of the fluid in the air-conditioning or refrigeration system; and
g) determining whether the fluid in the air-conditioning or refrigeration system has been altered by comparing the base-line profile of the labeled mixture with the test profile of the fluid in the air-conditioning or refrigeration system.

2. The method of claim 1, wherein said label is not normally present in said fluid.

3. The method of claim 1, wherein said label is deuterated.

4. The method of claim 2, further comprising a second label, wherein said chemical label is deuterated.

5. The method of claim 1, wherein said analysis comprises chromatography.

6. The method of claim 1, wherein said analysis comprises mass spectrometry.

7. The method of claim 4, wherein said analysis comprises chromatography and mass spectrometry.

8. The method of claim 1, wherein said lubricant is selected from the group consisting of mineral oil, alkyl benzenes, PAG oil, POE oil and combinations thereof.

9. The method of claim 1, wherein said label is a polynuclear aromatic hydrocarbon or a halogenated hydrocarbon.

10. The method of claim 9, wherein said label is selected from the group consisting of 1,2-diphenylbenzene; 1,4-diphenylbenzene; triphenylmethane; 1,3,5-triphenylbenzene; 1,1,2-triphenylethylene; tetraphenylethylene; 1,2,3,4-tetrahydrocarbazole; 4-4′-dichlorobenzophenone; 4-benzoylphenone; 4-bromobenzophenone; 4-methoxybenzophenone; 4-methylbenzophenone; 9-fluorenone; 1-phenylnapthalene; 3,3′-dimethoxybiphenyl; and 9-phenylanthracene.

11. The method of claim 1, wherein said label is selected from the group consisting of 1-(4-morpholino)-3-(alpha naphthylamino)-propane; 1-(4-morpholino)-3-(beta naphthylamino)-propane; 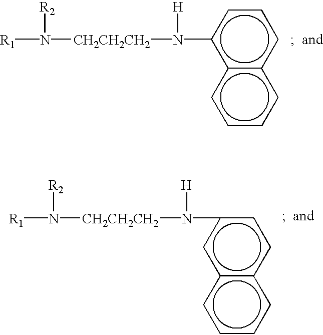
where R₁ and R₂ may each be hydrogen or alkyl having from one to twenty carbon atoms.

12. The method of claim 1, wherein said label has a formula: 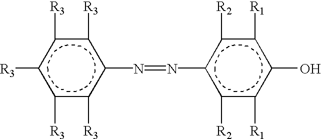
wherein the R₁'s and the R₂'s are the same or different and are each selected from —H and C₁-C₇ alkyls, provided that at least one R₁ is a C₃-C₇ alkyl, provided that the R₃'s are the same or different and are selected from —H, —NO₂, —Cl, —Br, —F, —CN, -Et and -Me, and provided that at least one R₃ is selected from —NO₂, —Cl, —Br, —F and —CN.
